(19) United States
(12) Patent Application Publication
(10) Pub. No.: US 2001/0032135 A1
(43) Pub. Date: Oct. 18, 2001

(54) Methods and system for the collection and delivery of information specific data

(76) Inventors: Michael Heisler, Tucson, AZ (US); James Thevenot, Tucson, AZ (US)

Correspondence Address: Snell & Wilmer L.L.P., One Arizona Center, 400 East Van Buren, Phoenix, AZ, 85004-2202, US

(21) Appl. No.: 09/797,221

(22) Filed: Mar. 1, 2001

Related U.S. Application Data
(60) Provisional application No. 60/186,134, filed on Mar. 1, 2000.
(60) Provisional application No. 60/186,135, filed on Mar. 1, 2000.

(51) Int. Cl. G06F 17/60

(52) U.S. Cl. 705/14

(57) ABSTRACT

A method and system for collecting and delivering information via a web-site on the Internet. The present invention collects information from consumers via an interactive web-site. The server system receives the collected information and uses it to build information specific messages or passes the collected information to another system or both. Alternatively, information specific messages may be built (created) off-line and delivered to the server system. In any event, such information specific messages may be delivered to the consumer in a variety of forms such as advertising banners, home improvement project design tips, product offers from third party businesses, or the like.

### CROSS-REFERENCE TO RELATED APPLICATIONS

This application claims the benefit of U.S. Provisional Application No. 60/186,134, filed Mar. 1, 2000, and U.S. Provisional Application No. 60/186,135, filed Mar. 1, 2000.

### BACKGROUND

1. Field of the Invention

The present invention generally relates to a computer method and system for the collection and delivery of data, and more particularly, to a computer method and system for the collection and delivery of information specific data over the Internet.

2. Description of the Related Art

In general, the Internet comprises a system of linked computer networks, international in scope, that facilitates the exchange of information. The linked computer networks contain computers that hold information, generally referred to as servers, which publish the information to the public in the form of web-sites. A user of the Internet can access the web-sites by graphically displaying the web-pages of a web-site in a browser (e.g., Netscape Navigator or Microsoft Internet Explorer) executing on the user's computer (often referred to as the client). The server responds to requests for web-pages from the browser by sending the information corresponding to the web-page to the client in the form of a Hypertext Markup Language (HTML) file.

As the Internet continues to mature, the conducting of business online (e-commerce) has grown more and more popular. However, while e-commerce is rapidly expanding, the ability to send useful information to consumers which they may have a need for is generally not recognized. Consumers browsing web-pages often receive information that is of little use. This is may be due to advertisers “pushing” information at a large number of consumers in the hope that the “pushed” information is of interest to at least a small number of the consumers that are reached. The “pushed” information often frustrates the user since it distracts without providing anything of value.

Information may be conveyed to the consumer in various forms, such as messages from the web-site provider, advertising information on the web-page, links to other web-sites, and even in a separate web-page that is displayed in a different window of the browser. For example, a high-rise apartment dweller living in Manhattan, New York, may be browsing a sports related web-site looking for information on basketball equipment. Suddenly, an advertising banner containing information for lawn care equipment pops up in an annoying animated Java applet that takes a long time to download. Since the apartment dweller does not have a lawn (and maybe has not even seen a lawn for some time) and the advertising banner is very annoying, they may leave the web-site in frustration.

In addition to frustrating the user, the provider of the additional information is also losing out, as resources are spent on providing the additional information. Moreover, not only is the advertiser wasting money on web-site advertisements that do not reach the proper audience, but the advertiser may even lose credibility with the Internet user. After all, the Internet user's time is valuable.

Information is also exchanged over the Internet in the form of electronic mail (e-mail). The sending and receiving of e-mail is perhaps the most popular use of the Internet, as e-mail provides the capability to send messages instantaneously anywhere in the world for less money than it costs to send a letter or to make a telephone call. However, the proliferation of junk e-mail, also known as spam, has increased rapidly and is burdensome to the consumer. Similar to traditional junk mail, spam is routinely ignored and immediately discarded by the e-mail user. The result of this is consumer frustration. In addition, unwanted, unsolicited e-mail can provide a consumer backlash against the sending party who can lose credibility with the consumer, and may even lose customers.

Accordingly, a need exists for a method and system of collecting and distributing information over the Internet so that the Internet user receives information that is relevant and specific to their interests.

### SUMMARY OF THE INVENTION

An embodiment of the present invention provides a method and system for collecting and delivering information specific data over the Internet. In accordance with one embodiment of the present invention, a home improvement web-site collects information from the consumer in the course of the consumer navigating through the web-site and designing a home improvement project or otherwise using the web-site. The collected information may be used by the server system of the web-site to build information specific messages which may be conveyed to the consumer in a variety of forms.

Alternatively, the collected information may be conveyed by the server system to another system such as a third party computer system. The third party system may use the information to deliver information specific messages to the consumer or the third party system may deliver information to the server system for delivery to the consumer of for use by the server system.

### BRIEF DESCRIPTION OF THE DRAWINGS

A more complete understanding of the present invention may be derived by referring to the detailed description when considered in connection with the following illustrative Figures, which may not be to scale. In the following Figures, like reference numbers refer to similar elements throughout the Figures.

FIG. 1 illustrates a schematic representation of an exemplary embodiment of a collection and distribution system in accordance with the present invention;

FIG. 2 illustrates a schematic representation of an exemplary embodiment of a client computer system in accordance with the system of FIG. 1;

FIG. 3 illustrates a schematic representation of an exemplary embodiment of a server computer system in accordance with the system of FIG. 1;

FIG. 4 illustrates a flow diagram of an exemplary embodiment of the operation of the system of FIG. 1; and

FIG. 5 illustrates an exemplary screen of the system of FIG. 1.

### DETAILED DESCRIPTION

Subject matter of the non-provisional patent application entitled “Home Improvement System” by inventors Michael Heisler et al., filed on the same date herewith, is hereby incorporated by reference.

The present invention may be described herein in terms of various software and hardware components and processing steps. It should be appreciated that such components may be realized by any number of software and hardware components configured to perform the specified functions. For example, the present invention may employ various databases, e.g., separate databases for addresses, home specific information, transaction history and the like, which may carry out a variety of functions under the control of one or more software applications or other control components. In addition, those skilled in the art will appreciate that the present invention may be practiced in any number of interactive contexts, such as the Internet, and that the preferred embodiments described herein are merely exemplary applications of the invention. Further, it should be noted that the present invention may employ any number of conventional techniques for database storing and retrieving, displaying text and graphics, sending files, and the like. Such general techniques that may be known to those skilled in the art are not described in detail herein.

As discussed above, a need exists for the interactive collection and delivery of information that is useful to consumers and tailored to their interests. In accordance with the present invention, a web-site is suitably configured to collect and store data from consumers, and then to query the data and distribute information specific messages to the consumers. Although the present invention may be used in conjunction with a variety of web-sites such as medical information web-sites, financial information web-sites, legal information web-sites, and the like, the present invention is conveniently described below in connection with a home improvement web-site.

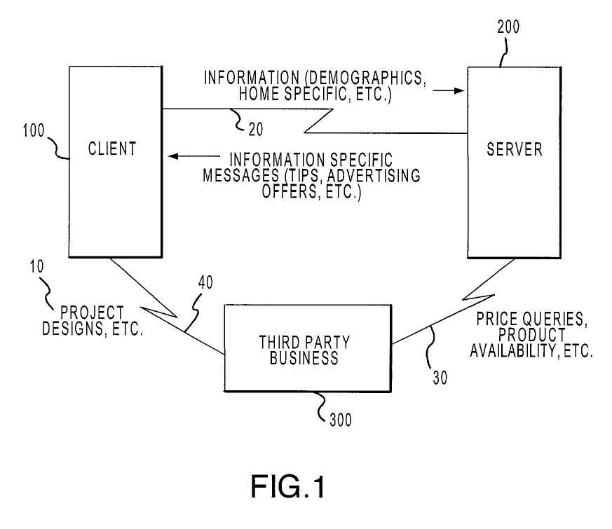

In accordance with an exemplary embodiment, with reference to FIG. 1, a collection and delivery of information system 10 suitably comprises a client system 100, a server system 200, and a third party computer system 300. In one embodiment, server system 200 is the host computer for a web-site that may be accessed via the Internet. In accordance with this embodiment, the consumer may access the web-site from client system 100 and display the various web-pages of the web-site on client system 100. As will be described in detail below, preferably server system 200 collects data from the consumer, which data is then used, for example in accordance with various aspects of the present invention, to deliver information specific messages to the consumer. The delivered messages are referred to as information specific messages, because, among other reasons, the delivered messages contain specific information that varies depending on the data collected from the consumer. Specific examples of information specific messages will be given, but it should be understood that these examples are only exemplars of information specific messages and are provided for illustrative purposes only; these exemplars are not intended to limit the scope of the present invention or the content or form of such messages.

Client system 100 suitably comprises a personal computer or similar device that is capable of accessing the Internet. Client system 100 may access server system 200 by using data connection 20. Data connection 20 may comprise any of a variety of known Internet connections such as a traditional public switched telephone network (PSTN), a T-1 line, an integrated services digital network (ISDN), a coaxial cable television system (i.e., cable television line) and a combination of the like.

In accordance with one aspect of the present invention, server system 200 is connected to third party computer system 300 by data connection 30. Data connection 30, similar to data connection 20, may also comprise any of a variety of known Internet connections. However, server system 200 may not be connected to third party 300. Instead, information may be conveyed in a non-electronic manner to third party 300, compiled, and resulting information specific messages sent to the consumer via an electronic connection or otherwise. As a result, computer system 300 may be a manual system or otherwise. In the context of a home improvement system, third party computer system 300 suitably comprises the computer system of a third party, home improvement related business such as Home Depot, Orbit Irrigation Products, the Scotts Company, and the like.

In accordance with another aspect of the present invention, collection and delivery system 10 may comprise more than one client system 100. Each client system 100 may independently access server system 200 and independently receive information. Similarly, system 10 may comprise more than one server system 200, each of which may be accessed by one or more client systems 100. In addition, system 10 may comprise zero or more third party computer systems 300.

In accordance with another aspect of the present invention, client system 100 is connected to third party computer system 300 by data connection 40. Like data connections 20 and 30, data connection 40 can comprise any of a variety of known Internet connections. However, client system 100 may not be connected to third party computer system 300. Instead, information may be conveyed in a non-electronic manner to third party computer system 300, compiled, and information specific messages may then be conveyed to the consumer in a non-electronic manner.

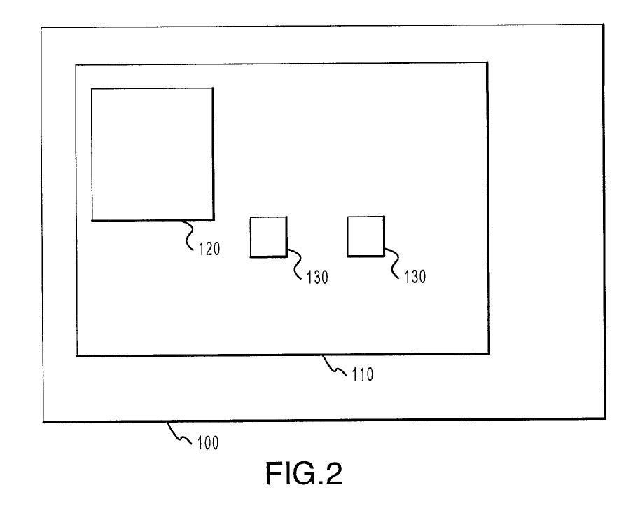

With reference to FIG. 2, client system 100 preferably comprises a computer 110 capable of running a web browser 120 such as Netscape Navigator, Microsoft Internet Explorer, or the like. In addition, zero or more cookies 130 may be present on client system 100. Cookies 130, as they are well known in the art, typically comprise text files that contain information about the computer on which they reside.

The consumer may use browser 120 to access server system 200. In a preferred embodiment, the consumer will use browser 120 in the form of an web browser as previously discussed. The consumer will then navigate to the web-site of server system 200 as will be described in detail below. However, server system 200, and particularly the web-site of server system of interest, may be accessed in any now known or hereafter devised manner or method. Moreover, it will be appreciated that more than one browser 120 may be running at the same time on client system 100, where each browser may be capable of simultaneously accessing server system 200. As is well known in the art, server system 200 may deposit cookies 130 on client system 100, where the cookies are used to store information about the client system and its users.

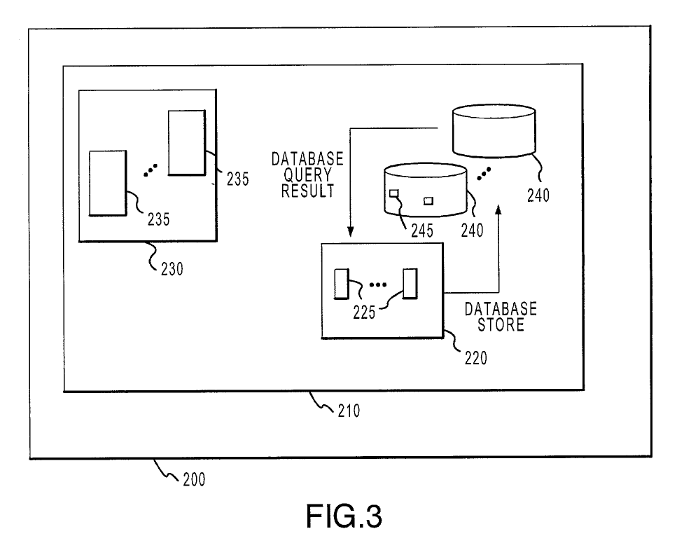

With reference to FIG. 3, server system 200 preferably comprises a host computer 210. Host computer 210 preferably comprises a server engine 220, one or more databases 240, and a web-site 230 that comprises one or more web-pages 235.

Server engine 220 suitably comprises one or more software components 225 for collecting information from the web-site visitor (e.g., consumer) and then delivering information specific messages to the visitor based on the collected information. Server engine 220 may store information collected from the web-site visitor in databases 240 or the equivalent, such as flat files. Databases 240 may use database tables 245, as it is well-known in the art, to store the collected information. The database tables may be in Oracle, Sybase, or any other database format. However, in accordance with various other aspects of the present invention, server engine 220 may instead convey the information to third party computer system 300 or otherwise utilize the information without storing the information. For example, server engine 220 may utilize the information and deliver information specific messages directly to the visitor without storing the collected information.

Server engine 220 may query the information stored in databases 240 using any database query language such as Structured Query Language (SQL) or the equivalent. Server engine 220 may use the database query results to deliver information specific messages as will be described in detail below. Such information specific messages, however, may be generated in other manners as will be discussed hereinbelow.

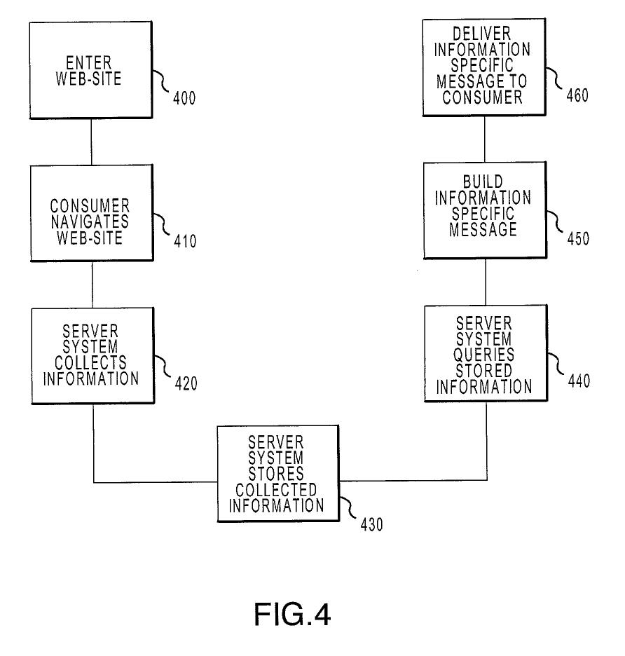

To more fully describe collection and delivery system 10 as may be used with a home-improvement web-site in accordance with the present invention, the operation of collection and delivery system 10 configured to provide information specific messages to consumers will now be described with reference to FIG. 4. However, it should be understood that the following description of this preferred operation is merely one example, provided for illustrative purposes only, and that the collection and delivery system of the present invention can be suitably operated in various other sequences as well, now known or hereafter devised. In addition, it should be understood that the examples of information specific messages are exemplary only, and the information specific messages may take a variety of other forms and content.

A consumer could enter web-site 230 in various ways as are well known in the art. Preferably, the consumer enters web-site 230 by using web-browser 120 (step 400). The consumer may navigate to the web-site by entering the Uniform Resource Locator (“URL”) directly into the browser. Alternatively, the consumer may use a search engine such as Yahoo or an already saved bookmark to access the web-site or any other known or hereinafter devised techniques for accessing a web-site.

The consumer preferably uses the web-browser to navigate through web-site 230 by selecting links to other web-pages. However, the consumer may navigate through the web-site by directly entering the URL of a web-page or by using a search feature or any other way of navigating through the web-site as is known in the art or hereinafter devised. As the consumer navigates through the web-pages of the web-site (step 410), client system 100 requests the web-pages from server system 200. Sever system 200 responds to the requests of client system 100 by sending the requested web-page to client system 100.

As the consumer navigates through the web-site, the server system may collect information from the consumer in various ways (step 420). The consumer may provide information by activating a button, selecting a menu item, entering text into a text field, using the cursor in a graphical fashion or any other similar operation. However, any now known or hereafter devised information collection operation may be used. Preferably, the information provided by the consumer is collected by server system 200. However, some information provided by the consumer may not be collected by the server system, but rather be used to activate a certain feature of the web-site, or navigate to a certain web-page of the web-site, or the like.

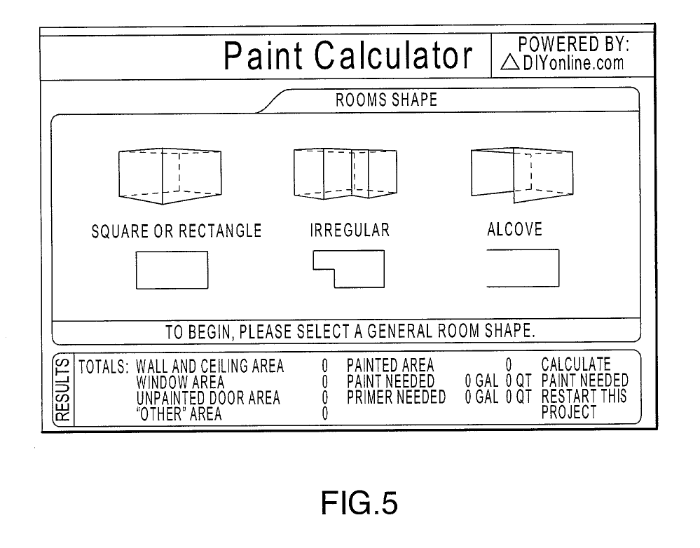

For example, and now with reference to FIG. 5, an exemplary web-page of web-site 230 is illustrated. The consumer may be prompted by the web-site to enter certain information such as the general room shape for the purposes of calculating the amount of paint needed to paint the room. The information that is entered by the consumer in response to the query may be collected (step 420) and preferably stored by server system 200 (step 430) as discussed above. However, in certain instances, information storage (430) may not take place as the information is readily used and discarded.

Other examples of information collected by server system 200 in the context of the paint calculator (see FIG. 5), are room features such as the presence of fireplaces, or the type of ceiling, such as a flat ceiling or a vaulted ceiling. These examples of collected information are exemplary only, and are not meant to limit the scope of the present invention or the type or format of information that is collected. Information may be collected in the context of a variety of home improvement projects such as kitchen designing, bathroom designing, wallpapering, sprinkler designing, deck designing, or any other home improvement project that are known or contemplated.

At the point of information collection, or at any later point, server system 200 may then query the stored collected information (step 440) and build an information specific message (step 450). Alternatively, or in addition to using the information, server system 200 may convey the collected information to another system, such as third party computer system 300. The third party system may then use the information to build an information specific message for delivery to the consumer.

For example, server system 200 may query the database in order to ascertain if the consumer has a fireplace. As previously noted, the consumer may have entered fireplace information for the purpose of calculating the amount of paint needed for a room. Alternatively, server system 200 may have collected the fireplace information without storing the information. If the user has indicated that there is a fireplace present, then server system 200 may deliver an information specific message (step 460) that contains information specific to fireplaces. An example of such a message is an advertising message for starter logs from a company such as Duraflame. Such a message would probably only be of interest to a consumer who has a fireplace, and the system of the present invention would preferably only deliver such a message to a consumer who has indicated that they have a fireplace.

In another example, if the consumer had indicated that they have a vaulted ceiling in one of the rooms of their house, then this information could be collected and used. Server system 200 could use this information to deliver an information specific message that contains an offer from a specific business entity for a chandelier. Preferably, the information specific message contains up-to-date pricing and availability information obtained from the third part computer system 300 over data connection 30. However, the information specific message may not contain any pricing or availability information.

Alternatively, server system 200 may convey the collected information to any other entity, such as third party computer system 300, for their use and generation of an information specific message for delivery to the consumer via server system 200 or otherwise.

In accordance with a still further embodiment of the present invention, and still in the context of a home-improvement web-site, as the consumer is browsing web-pages concerning the design of a sprinkler system, server system 200 may query the consumer as to the type of plants, trees, and shrubs in the consumer's yard. If the consumer has entered information indicating that they have ten rose bushes in their yard, then server system 200 may use this information to send an information specific message that provides information about taking care of rose bushes. For example, such an information specific message may comprise a message offering tips on the type of plant food to feed rose bushes. Alternatively, such a message may comprise an offer from a specific third party (e.g., a plant food manufacturer) containing a coupon for the third party's plant food. It should be appreciated in light of the foregoing disclosure that such information specific messages are of benefit to both the consumer and to the third party. That is, benefit to the consumer is realized because the messages contain information that is specific to a topic that is calculated to be of interest to the consumer. In the current illustrative example, in that the consumer has indicated that he has rose bushes, a message containing information about rose bushes likely will be of interest to the consumer. Consumers with no rose bushes, or at least not providing information relative to such possessions, preferably would not receive such messages concerning taking care of rose bushes. The information specific messages are also of benefit to the third party business, because the third party business is able to target consumers who may be in the market for the specific products or services that the third party business provides.

In the context of various aspects of the present invention, the consumer may be invited to download information to and/or from third party computer system 300 along data connection 40. For example, the consumer may download a home improvement project to third party computer system 300 at a store such as Home Depot or the like. The home improvement project design may then be accessed by the third party business. Alternatively, the consumer may convey information to the third party business in a non-electronic manner such as hard copy printouts, a floppy disk containing information, or the like.

As will be appreciated from the foregoing description, the data gathering or information collection aspect of the present invention is preferably part of a process which is providing the consumer with useful information or materials. For example, in connection with the paint calculation example hereinabove described, the information which is utilized in creating the information specific message of the present invention is information which is related to, but not necessarily related directly to, the specific message. Stated another way, the fireplace targeted message is, in general, unrelated to the purpose the consumer visited the site in the first place, namely to figure out how much paint is needed to paint a particular room.

In other cases, and in accordance with other aspects of the invention, the information specific message may be directly related to or responsive to the information collected. For example, sales information from a third party business in proximity to a consumer's location may be sent in response to information relating to the consumer's location.

The present invention has been described above with reference to exemplary embodiments. However, those skilled in the art will recognize that changes and modifications may be made to the exemplary embodiment without departing from the scope of the present invention. For example, the various components of the collection and distribution of information system may be implemented in alternate ways depending upon the particular application or in consideration of any number of cost functions associated with the operation of the system, e.g, the databases may be configured in different sequences or to store different tables of data. In addition, the techniques described herein may be extended or modified for use with various other applications, such as, for example, a medical information web-site. These and other changes or modifications are intended to be included within the scope of the present invention.

What is claimed is:

1. In an interactive computer system for designing a variety of home improvement projects, a method of providing information specific data to a consumer comprising the steps of:
collecting information from the consumer while the consumer designs a home improvement project, wherein the collected information is related to the home improvement project;
building information specific data that corresponds to the collected information; and
providing the information specific data to the consumer while the consumer designs the home improvement project.

2. The method of claim 1 further comprising the step of storing the collected information in a database.

3. The method of claim 1 further comprising the step of querying the collected information.

4. The method of claim 1, wherein the information specific data comprises a targeted advertisement

5. The method of claim 1, wherein the information specific data comprises tips for completing the home improvement project.

6. The method of claim 1, wherein the information comprises localized information including details on building code requirements, building permits, and warnings.

7. The method of claim 1 further comprising the step of obtaining the information specific data from a third party.

8. The method of claim 1 further comprising the step of conveying the home improvement project design to the third party.

9. The method of claim 1 further comprising the step of conveying the collected information to a third party.

10. The method of claim 9 further comprising the step of the third party providing the information specific data to the consumer.
